(19) United States
(12) Patent Application Publication
(10) Pub. No.: US 2006/0042316 A1
(43) Pub. Date: Mar. 2, 2006

(54) Method of manufacturing hermetically sealed container and image display apparatus

(75) Inventors: Mitsutoshi Hasegawa, Yokohama-shi (JP); Toshiaki Himeji, Kamakura-shi (JP); Shin Matsui, Fujisawa-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/206,030

(22) Filed: Aug. 18, 2005

(30) Foreign Application Priority Data
Aug. 24, 2004 (JP) 2004-243621

(51) Int. Cl. C03B 23/24

(52) U.S. Cl. 65/58

(57) ABSTRACT

In a method of manufacturing a hermetically sealed container with a pair of substrates caused to undergo joining in an atmosphere of reduced pressure, one side of one substrate is introduced into the atmosphere of reduced pressure in a state of having undergone joining to the other substrate, and spacing between the other side of that one substrate and the other substrate is widened in the atmosphere of reduced pressure and thereby spacing between the both substrates are released in the atmosphere of reduced pressure so as to thereby make it easy to form a vacuum container between the both substrate.

### BACKGROUND OF THE INVENTION

1. Field of the Invention

The present invention relates to a method of manufacturing a hermetically sealed container that is comprised by an image display apparatus etc.

2. Related Background Art

Japanese Patent Application Laid-Open No. H06-196094 has disclosed a method of manufacturing a vacuum display apparatus having a glass container with glass on a display surface and substrate glass that have undergone sealing with low-melting glass comprising: a step of assembling a glass container with low-melting point rod glass that intervenes between glass on a display surface and substrate glass; a step of vacuum pumping inner air from a gap provided in a glass container; and a step of brings low-melting point rod glass into seal bonding in a state of keeping undergoing vacuum pumping.

In addition, Japanese Patent Application Laid-Open No. 2001-028241 has disclosed a method of manufacturing an image forming apparatus by seal bonding, through a connecting member, a first substrate with phosphor body excitation means being disposed thereon and a second substrate with a phosphor body to emit light with phosphor body excitation means being disposed thereon, wherein, a heating process of heating a first substrate, a second substrate and a connecting member to reach a seal bonding temperature while vacuum pumping goes on inside a chamber with the first substrate and the second substrate being retained between first heating means and second heating means in a state so as not to bring the seal bonding parts into contact in a chamber and a seal bonding process of seal bonding the first substrate and the second substrate through the connecting member with a seal bonding parts in contact in a state of having undergone vacuum pumping inside the chamber. According to the manufacturing method disclosed in this Japanese Patent Application Laid-Open No. 2001-028241, vacuum pumping and heat processing are implemented in such a state that the two substrates are retained in a desired distance so as not to be brought into contact.

In the configuration having been disclosed in Japanese Patent Application Laid-Open No. 2001-028241, in order to retain the first substrate and the second substrate in a state not to be brought into contact with the seal bonding parts, it is necessary that at least one substrate is held to position adjustment means with a holding jig etc. and that held substrate in its entirety is caused to travel in a direction farther apart from the other substrate with position adjustment means to form a gap between the both substrates.

However, such a configuration that causes a substrate in its entirety held onto position adjustment means with a holding jig etc. to travel in the direction farther apart from the other substrate will give rise to a waste of spacing (dead stroke) larger than sufficient spacing to cause space between the both substrates to undergo vacuum pumping. In a configuration that gives rise to such a dead stroke, a manufacturing apparatus will become larger only for that portion, and in addition, it will take more travel time of a substrate only for that portion, which, therefore, a cut of manufacturing time will be prevented.

### SUMMARY OF THE INVENTION

An object of the present invention is to provide a method of manufacturing a hermetically sealed container that undergoes pumping in space between substrates without causing a dead stroke to arise between the substrates and a method of manufacturing an image display apparatus.

The present invention is a method of manufacturing a hermetically sealed container comprising a process of disposing, in atmosphere of reduced pressure, a pair of substrates in a state that respective substrate surfaces facing each other to form a gap therebetween and a side of one of the substrates is joined with the other substrate; and a process of widening the above described gap between another side of the above described one of substrates and the above described other substrate in the above described atmosphere of reduced pressure.

In addition, the present invention is a method of manufacturing an image display apparatus comprising a hermetically sealed container involving electron-emitting devices and a phosphor film to which electrons emitted from the above described electron-emitting devices are radiated, wherein forming of the above described hermetically sealed container comprising a process of disposing, in atmosphere of reduced pressure, a pair of substrates in a state that respective substrate surfaces faces each other to form a gap therebetween and a side of one of the substrates is joined with the other substrate; and a process of widening the above described gap between another side of the above described one of substrates and the above described other substrate in the above described atmosphere of reduced pressure.

### BRIEF DESCRIPTION OF THE DRAWINGS

FIGS. 1A, 1B and 1C show flows of processes and a schematic configuration of a method of manufacturing an image display apparatus related to an embodiment of the present invention;

FIGS. 2A, 2B and 2C show, in a stepwise fashion, processes of manufacturing a hermetically sealed container related to an embodiment of the present invention;

FIG. 3 is a diagram showing a process of positioning between a rear plate and a face plate;

FIGS. 4A, 4B and 4C show positioning jigs as means of positioning and holding a side of one of plates to a predetermined position of the other plate;

FIG. 5 shows a state where a plate is attached to the positioning jig shown in FIGS. 4A, 4B and 4C;

FIGS. 6A and 6B show arms being gap forming means of forming a gap between the both plates;

FIGS. 7A and 7B show positioning springs as means of positioning and holding a side of one of plates to a predetermined position of the other plate; and

FIGS. 8A and 8B show heating mechanism for heating plates.

### DETAILED DESCRIPTION OF THE PREFERRED EMBODIMENTS

A method of manufacturing a hermetically sealed container of the present invention is characterized by having a process of disposing, in atmosphere of reduced pressure, a pair of substrates with respective substrate surfaces facing each other in a gap in a state with a side of one of the substrates being joined with the other substrate and a process of widening the above described gap between another side of the above described one of substrates and the above described other substrate in the above described atmosphere of reduced pressure.

In addition, a method of manufacturing an image display apparatus of the present invention is a method of manufacturing an image display apparatus comprising a hermetically sealed container involving electron-emitting devices and a phosphor film to which electrons emitted from the above described electron-emitting devices are radiated, wherein forming of the above described hermetically sealed container has a process of disposing, in atmosphere of reduced pressure, a pair of substrates with respective substrate surfaces facing each other in a gap in a state with a side of one of the substrates being joined with the other substrate and a process of widening the above described gap between another side of the above described one of substrates and the above described other substrate in the above described atmosphere of reduced pressure.

According to the above described method of manufacturing a hermetically sealed container and an image display apparatus of the present invention, sufficient pumping can be implemented in space between the above described substrates through the bare minimum of gap between a pair of opposite substrates.

As having been described above, according to the present invention, the gap between the substrates can undergo pumping without causing a dead stroke to arise between the substrates.

Next, an embodiment of the present invention will be described with reference to drawings.

A method of manufacturing a hermetically sealed container of the present invention includes a method of manufacturing a glass container, which has a pair of opposite glass plates, with space of its inside being hermetically sealed or a hermetically sealed container etc. that is comprised by an image display apparatus with a built-in electron-emitting element or an image display apparatus such as a plasma display. In particular, the method of manufacturing an image display apparatus is a preferable mode to which the present invention is applied from a point of view of cost reduction.

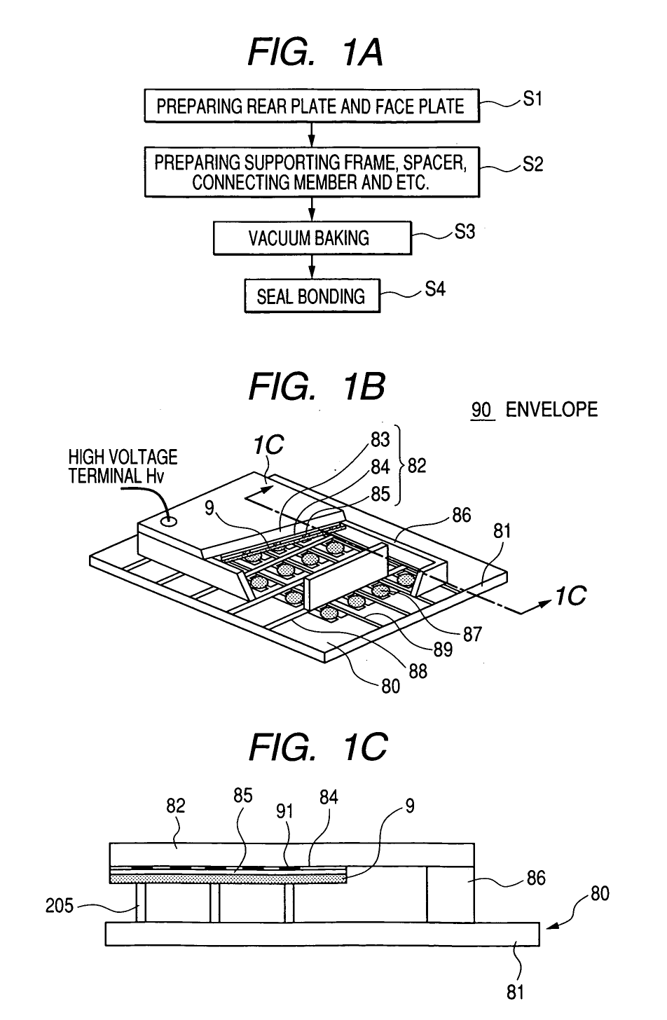

Exemplifying an image display apparatus comprising a hermetically sealed container building in electron-emitting devices and a phosphor film to which electrons emitted from the above described electron-emitting devices are radiated, an embodiment of the present invention will be specifically described with reference to FIGS. 1A, 1B, 1C, 2A, 2B, 2C and 3 as follows.

FIGS. 1A, 1B and 1C show flows of processes and a schematic configuration of a method of manufacturing a hermetically sealed container of an image display apparatus related to an embodiment of the present invention. FIG. 1A is a flow chart showing a flow of processes of a method of manufacturing a hermetically sealed container of an image display apparatus related to the present embodiment, FIG. 1B is a perspective view showing a schematic configuration of a hermetically sealed container of an image display apparatus related to the present embodiment and FIG. 1C is a sectional view along 1C-1C shown in FIG. 1B.

At first, a configuration of a hermetically sealed container of an image display apparatus related to the present embodiment will be described with reference to FIGS. 1B and 1C. A hermetically sealed container 90 of an image display apparatus related to the present embodiment is configured by a rear plate 81, a face plate 82 and a supporting frame. 86. The rear plate 81 has, for example, a glass substrate 80, a plurality of electron-emitting devices 87 arranged on the surface thereof and wirings 88 and 89 connected to these electron-emitting devices 87. The face plate 82 has, for example, a glass substrate 83 together with a phosphor film 84, a metal back 85 and a non-evaporable getter 9 which are disposed on the surface, that is opposite to the rear plate 81, of the substrate 83. The supporting frame 86 is disposed between the rear plate 81 and the face plate 82 in order that the rear plate 81 and the face plate 82 are disposed oppositely each other in predetermined spacing. A connecting portion of the respective plates 81 and 82 and the supporting frame 86 are bonded each other with flit glass or In etc.

In the present embodiment, a supporting body called a spacer 205 is installed between the rear plate 81 and the face plate 82. Thereby, even in the case where an image display apparatus is a so-called large area panel, the hermetically sealed container 90 has sufficient strength against the atmospheric pressure. In the hermetically sealed container 90, plate thickness of the plates 81 and 82 and placement of the spacer 205 etc. are appropriately designed depending on physical conditions etc. such as atmospheric pressure resistant structure etc. for keeping the inside part vacuumed.

As the glass substrate 80, a substrate made of inexpensive blue plate glass is generally used, and in that case a silicon oxide film with 0.5 μm thickness is preferably formed as a sodium block layer on the glass substrate 80 with a sputtering method. Otherwise, the glass substrate 80 can be made of a glass or silica substrate with little sodium or sodium free alkali glass substrate. For a plasma display, PD-200 (produced by ASAHI GLASS CO., LTD.) etc. being electric glass with few alkali components can be appropriately used as the glass substrate 80.

As the glass substrate 83, inexpensive blue plate glass is generally used as in case of the glass substrate 80, and in the present embodiment, PD-200 (produced by ASAHI GLASS CO., LTD.) etc. being electric glass for a plasma display with few alkali components can be used. This glass material does not give rise to the coloring phenomena of glass, and plate thickness of around 3 mm derives sufficient shielding effects to restrain secondary arising soft X ray leakage even in case of drive with an accelerating voltage 10 kV or more.

As a material of the spacer 205, a substrate made of inexpensive blue plate glass is also generally used, but selected to fit into application of the hermetically sealed container 90. In the case where positional accuracy of the spacer 205 is required, the material of the spacer 205 preferably corresponds to the glass substrates 80 and 83 in terms of coefficient of thermal expansion with the same material. In addition, the spacer 205 should be shaped appropriate for applications such as to resemble a plate, a cylinder, a prism or a sheet etc. and the number of installation thereof is also appropriately set in accordance with applications. In case of the hermetically sealed container 90 with a built-in electron-emitting device 87, the spacer 205 is designed to adapt itself to the electron trace.

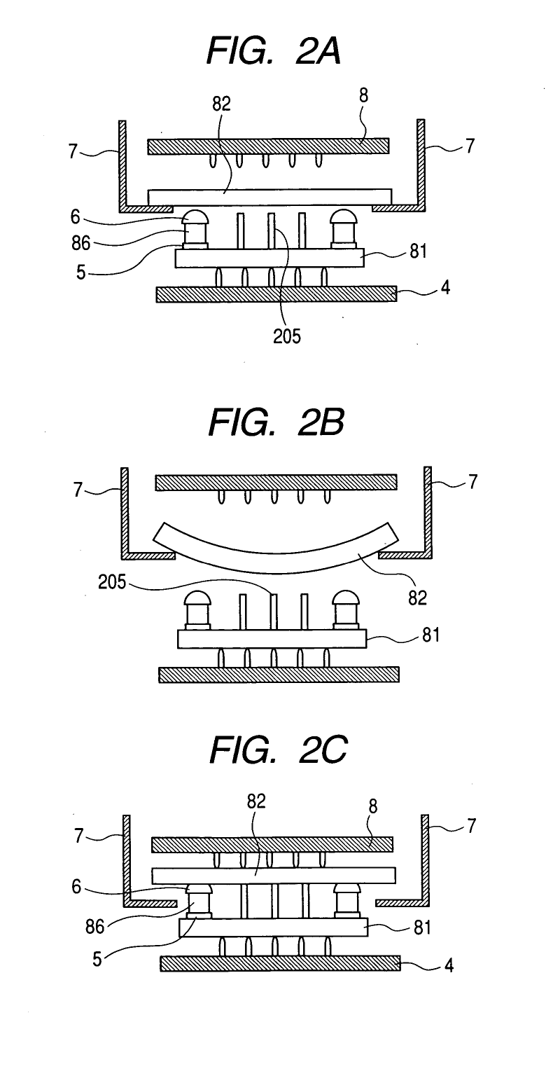

As connecting members 5 and 6 of connecting the respective plates 81 and 82 and the supporting frame 86 (see FIGS. 2A, 2B and 2C), flit glass having around the same coefficient of thermal expansion as in the glass substrates 80 and 83 or low-melting metal selected from the group consisting of In, In-Ag or In-Sn etc. Different materials may be used for the respective connecting members 5 and 6 or the same material may be used. As an example, for both of the connecting members 5 and 6, In or In-Ag is preferably used.

It is advisable that the connecting members 5 and 6 are coated on at least one of the respective plates 81 and 82 and the supporting frame 86. In addition, the connecting members 5 and 6 are coated so that the sum of thickness before the respective plates 81 and 82 and the supporting frame 86 are connected is sufficiently large compared with thickness after connection. In the present embodiment, coating is implemented to derive 300 μm of thickness of an In film 93 (see FIGS. 2A, 2B and 2C etc.) formed with the connecting members 5 and 6.

In the face plate 82, on the surface, that is opposite to the rear plate 81, of the glass substrate 83, a phosphor film 84, a metal back 85 and the non-evaporable getter 9 are formed and these parts will become an image display area. The location where non-evaporable getter 9 of the face plate 82 is installed is on a black electrically conductive member 91 between the top surface of the metal back 85 and the phosphor film 84 of the face plate 82. The non-evaporable getter 9 is desired to be disposed to sweep across the image display area.

Here, the non-evaporable getter 9 is formed with a vacuum evaporation method such as an electron beam and sputtering etc. with a material containing Ti as a main component. In the present embodiment, thickness of the non-evaporable getter 9 was set to 800 Å (80 nm). However, the installation location and film thickness of the non-evaporable getter 9 will not be limited to the above described, but can be appropriately designed and set.

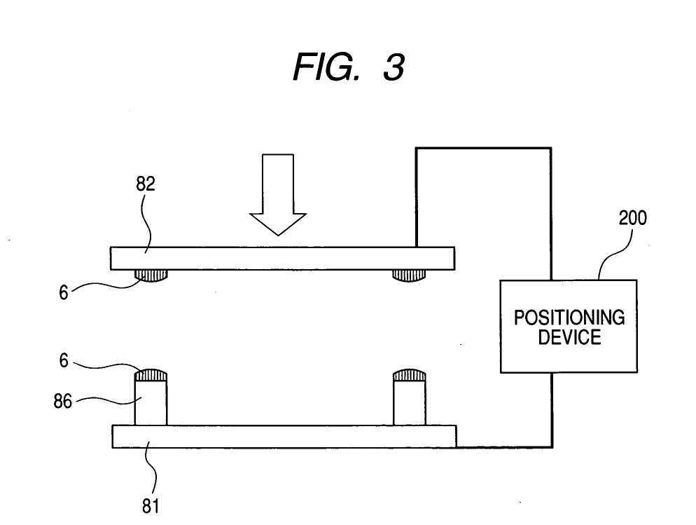

Next, processes of manufacturing a hermetically sealed container related to the present embodiment will be described with reference to FIGS. 1A, 2A, 2B, 2C and 3. FIGS. 2A, 2B and 2C show, in a stepwise fashion, processes of manufacturing a hermetically sealed container related to an embodiment of the present invention and FIG. 3 is a diagram showing a process of positioning between a rear plate and a face plate.

At first, a rear plate (RP) 81 and a face plate (FP) 82 are prepared (Step 1).

Next, as shown in FIG. 2A, the rear plate 81 is mounted on a lower side supporting member 4, a predetermined location on the rear plate 81 is coated with a connecting member 5, a supporting frame 86 is mounted on the coated connecting member 5 and next the upper surface of the supporting frame 86 is coated with a connecting member 6. A portion of a face plate 82 to be connected to the upper surface of the supporting frame 86 is coated with a connecting member. In the present embodiment, In was used as the connecting member hereof. Moreover, spacers 205 are installed in predetermined locations of the rear plate 81.

Here, in the case where the hermetically sealed container 90 to be made is a color image display apparatus, the both plates 81 and 82 need to undergo positioning so that phosphor bodies of respective colors of the phosphor film 84 correspond with electron-emitting devices 87 on the rear plate 81. Therefore, in the present embodiment, with positioning device 200 (see FIG. 3) of implementing mutual positioning of the plates 81 and 82, the both plates 81 and 82 undergo positioning sufficiently. The positioning device 200 causes at least one of the plates 81 and 82 to travel to the other in the vertical and horizontal directions (XY directions) in a plane surface of the plate and in the rotary direction (θ direction). Subject to positioning a side of one of plates to a predetermined location of the other plate with the positioning device 200, that site that has undergone positioning is held. Thereby a side of one of plates is positioned to a predetermined position of the other plate and is joined with the other plate. It is advisable that this joining work is implemented prior to a seal bonding process to be described later. Accordingly the above described joining work may be implemented in an atmosphere of atmospheric pressure before the plates 81 and 82 are introduced into a (not shown) sealing chamber for manufacturing the hermetically sealed container 90 or may be implemented in an atmosphere of reduced pressure after they have been introduced into the sealing chamber.

Here, in case of a configuration without installation of the electron-emitting devices or the phosphor film etc. on the plate, accuracy required for mutual positioning of the plates is not so intensive, therefore a positioning device 200 as described above is not always necessary.

As having been described above, in the present invention, join of a side of one of plates (for example, the above described one of plates) to the other plate (for example, the other plate described above) is preferably joined to hold relative position of a pair of substrates in the direction along a substrate surface of the pair of substrates (for example, the above described one of the plates and the other plate).

In addition, this join includes the case of being implemented between a side of the above described one of the substrates and the above described other substrate via the above described connecting member or the above described supporting frame and will not be limited to the case where a side of the above described one of the substrates is joined to the above described other substrate directly.

Thus, in the state of having implemented mutual positioning and holding of the both plates 81 and 82 with the supporting frame 86 and the spacers 205 which have been incorporated, these members are introduced into the seal bonding chamber and the preparation process is finished (Step 2).

Next, vacuum baking is implemented under a baking condition of 400° C. for an hour in the present embodiment (Step 3). This baking condition is appropriately set to fit into application of the hermetically sealed container 90 to be made. At this time, widening, at least, spacing between the other side different from a side of the above described one of plates that has been used for positioning as described above and the above described other plate, space between the plates 81 and 82 undergoes vacuum pumping sufficiently. Here, the other side which is different from a side of the above described one of plates is preferably a side being opposite to this side. In addition, in case of widening the above described spacing, regardless whether or not a site in the vicinity of the center of the plates 81 and 82 is in contact to the spacer 205, if there is a gap of around 1 mm between the both parties in the vicinity of the periphery of the plates 81 and 82, space between the plates 81 and 82 undergoes vacuum pumping sufficiently in the vicinity of the center as well (see FIG. 2B).

Thereafter, as shown in FIG. 2C, the face plate 82 is mounted on the supporting frame 86 and the above described widened spacing between the both plates 81 and 82 is returned to the original so as to close the gap between the supporting frame 86 and the above described one of plates and to implement seal bonding at a temperature to melt the connecting members 5 and 6 (Step 4). In the present embodiment, the seal bonding process was implemented under such a condition that the temperature of the plates 81 and 82 was set to fall within the range of 160° C.±5° C. Here, FIGS. 2A, 2B and 2C are the diagrams looked at from the side of a side opposite to a side of the above described one of plates.

At the time of seal bonding, a vacuum level of not more than 1×10⁻⁶ [Torr] (approximately 1.3×10⁻⁴ [Pa]) is required. Moreover, in order to retain the vacuum level inside the hermetically sealed container 90 subject to seal bonding, getter processing is occasionally implemented. Here, getter processing is processing of heating, immediately prior to seal bonding a getter or subject to seal bonding, a getter having been disposed in a predetermined location (not shown) inside the hermetically sealed container 90 in advance to form a (not shown) evaporation film. In this case, a getter member normally contains Ba etc. as a main component and absorption by an evaporation film formed as described above will enable the vacuum level inside the hermetically sealed container 90 to be retained to fall within the range of, for example, 1×10⁻⁵ to 1×10⁻⁷ [Torr] (approximately 1.3×10⁻³ to 1.3×10⁻⁵ [Pa]).

Here, specific configurations of means of positioning a side of one of plates to a predetermined location of the other plate to join and means of widening spacing between another side different from a side of one of the plates and the other plate at the time of implementing vacuum baking will be described.

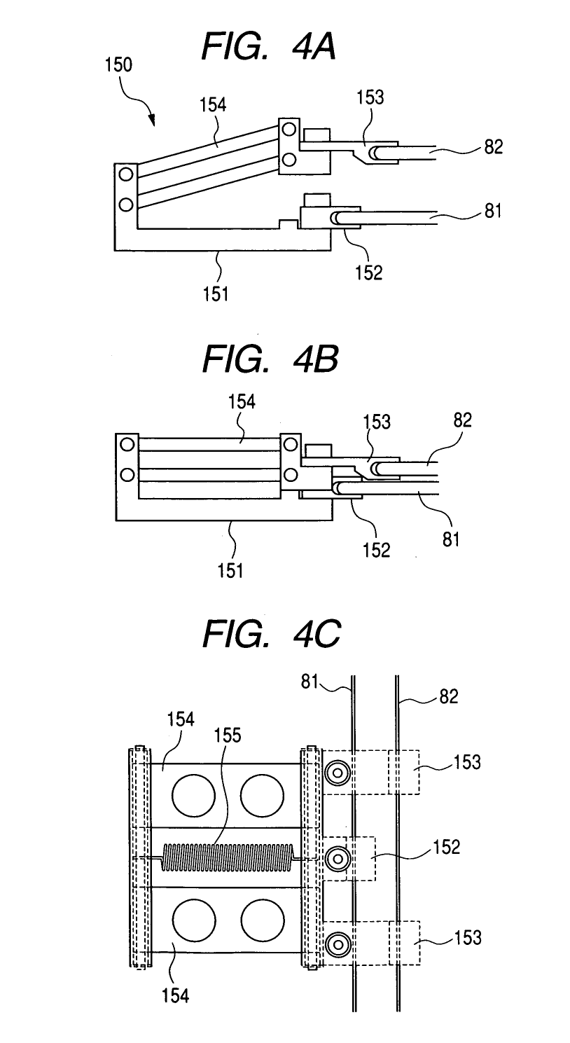

FIGS. 4A, 4B and 4C show positioning jigs as means of positioning a side of one of plates to a predetermined location of the other plate to join.

The positioning jig 150 has a base 151 to hold a lower clamp 152 which grasps the rear plate 81 and an upper clamp 153 which is installed removably to the base 15.1 via an arm link 154 and grasps the face plate 82. The positioning jig 150 is provided with a spring 155, and the positioning jig 150 is normally in a state with the upper clamp 153 being lifted to a position shown in FIG. 4A with this spring 155. On the other hand, in a state with the upper clamp 153 grasping the face plate 82, the upper clamp 153 will be lowered to a position shown in FIG. 4B with the weight of the face plate 82.

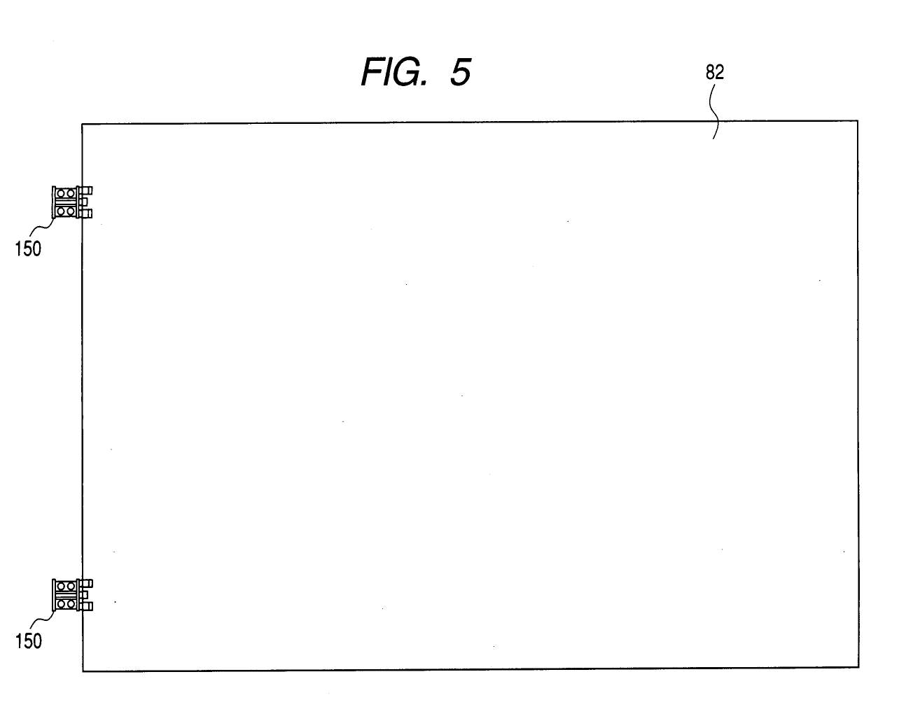

As shown in FIG. 5, two positioning jigs 150 are used as a group, and the two positioning jigs 150 grasp a side of one of the two plates 81 and 82. The respective plates 81 and 82 are inserted in a state of undergoing positioning to the clamps 152 and 153 of the positioning jig 150 with the positioning device 200 shown in FIG. 3. Thereby, in the respective plates 81 and 82, a side of one of the plates undergoes positioning to a predetermined position of the other plate.

After thus positioning a side of one of the respective plates 81 and 82 to the clamps 152 and 153 of the positioning jig 150, contact portions between the clamps 152 and 153 and the respective plates 81 and 82 are coated with a connecting agent such as Aron ceramics of TOAGOSEI CO., LTD., for example, and the like and are vulcanized at 120° C. to hold. Thereby, in the plates 81 and 82, a side of one of the plates undergoes positioning to the other plate and joining. The positioning jig 150 is thus incorporated into a product in a state of being held by the plates 81 and 82, and therefore preferably has the same coefficient of thermal expansion as that for the respective plates 81 and 82. Therefore, in the present embodiment, the base 151 and the clamps 152 and 153 of the positioning jig 150 are made by carving out from PD200 (produced by ASAHI GLASS CO., LTD.) being the same material as that for the respective plates 81 and 82.

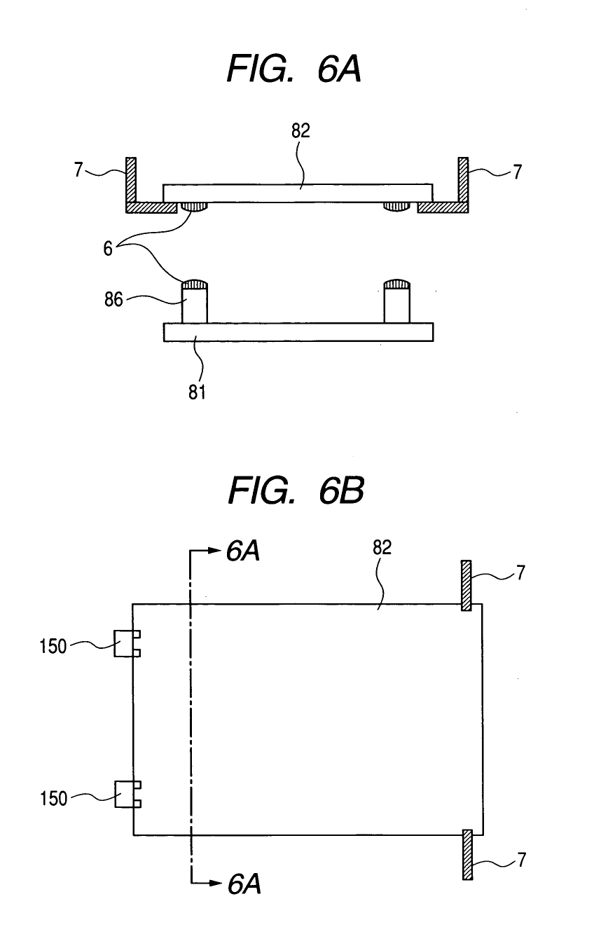

FIGS. 6A and 6B show arms being means of widening spacing between the other side different from the side of one of the plates and the other plate, and FIG. 6A is a sectional diagram thereof while FIG. 6B is a plan view looked at from an upper direction. Here, FIG. 6B shows the arm 7 in a state of partially in phantom.

In the present embodiment, arms 7 capable of lifting portions in the vicinity of one side and the opposite other side, that have undergone positioning with the positioning jig 150, of the face plate 82 are provided inside the seal bonding chamber. According to this configuration, when the arms 7 lifts the portions in the vicinity of the other side of the face plate 82, the portions in the vicinity of the other side is lifted and the armlink 154 of the positioning jig 150 is also lifted as shown in FIG. 4A. Accordingly, also in the side of the above described one side that has undergone positioning and joining with the positioning jig 150, spacing between the both plates 81 and 82 are more or less widened. Thus, lifting the face plate 82, conductance between two plates 81 and 82 to undergo vacuum seal bonding can be secured, and consequently, the plates 81 and 82 can undergo seal bonding together in a state with inner space thereof having undergone vacuum pumping well. In addition, in the configuration of the present embodiment, special control or apparatus except the arms 7 of causing the face plate 82 to move upward and downward, an apparatus of driving it and the positioning jig 150 of the both plates 81 and 82, costs of an apparatus for making an outer periphery device 90 can be reduced.

As having been described above, in the present invention, join of a side of one of plates (for example, the above described one of plates) to the other plate (for example, the other plate described above) is preferably movably joined in the direction other than the direction along a substrate surface of the pair of substrates (for example, the above described one of the plates and the other plate).

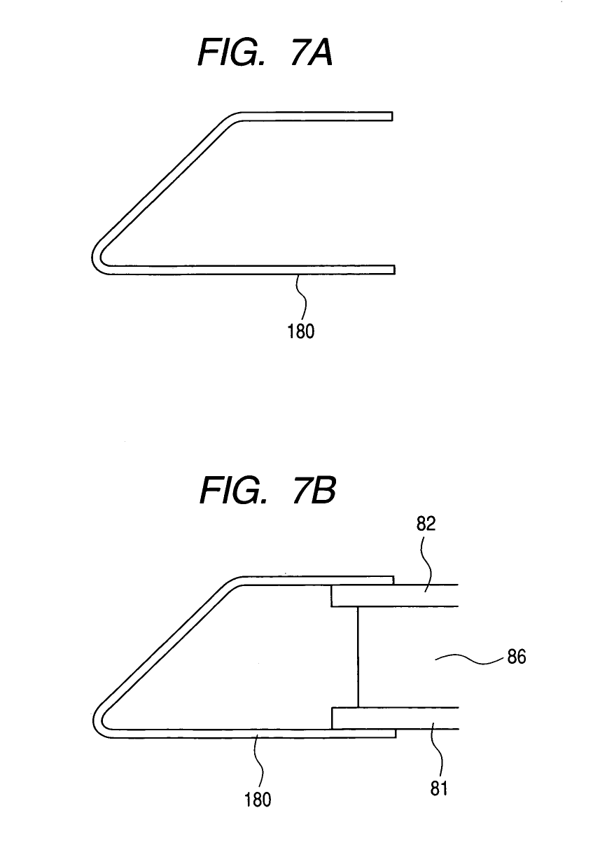

FIGS. 7A and 7B show positioning springs as means of positioning and joining a side of one of the plates to a predetermined position of the other plate. This positioning spring is used in place of the above described positioning jig.

As shown in FIGS. 7A and 7B, the positioning spring 180 has a clip-like shape and is formed so as to be capable of sandwiching the respective plates 81 and 82 which have been connected to the upper and the lower surface of the supporting frame 86.

The respective plates 81 and 82 undergo positioning each other with a positioning device 200 as shown in FIG. 3, and thereafter, two positioning springs 180 are attached to the one side side of the plates 81 and 82 as shown in FIG. 7B and thereby undergo positioning each other. In order to keep that positioning state, contact portions between the positioning springs 180 and the respective plates 81 and 82 are coated with a connecting agent such as Aron ceramics of TOAGOSEI CO., LTD., for example, and the like and are vulcanized at 120° C. to hold. The positioning spring 180 is thus incorporated into a product in a state of being held by the plates 81 and 82, and therefore preferably has the same coefficient of thermal expansion as that for the respective plates 81 and 82. Therefore, in the present embodiment, the positioning springs 180 were configured by a nickel alloy having the same coefficient of thermal expansion as PD200 (produced by ASAHI GLASS CO., LTD.) being a material of the respective plates 81 and 82.

Also in the case where such positioning springs 180 are used, the arm 7 shown in FIGS. 6A and 6B lifts the portion in the vicinity of the other side, which has undergone positioning with the positioning springs 180, of the face plate 82 being opposite to one side joined to the rear plate 81 and thereby can widen spacing between the two plates 81 and 82 at the above described side of the other side. Thus, lifting the face plate 82, conductance between two plates 81 and 82 to undergo vacuum seal bonding can be secured, and consequently, the plates 81 and 82 can undergo seal bonding together in a state with inner space thereof having undergone vacuum pumping well.

Here, at the time when the arm 7 lifts the face plate 82, the side of the side sandwiched by the positioning springs 180 of the both plates 81 and 82 is apt to get separated, but in this case, deflects in the direction widening the positioning springs 180, and therefore the positioning springs 180 will not press forcibly the plates 81 and 82 apt to spread each other so as to end in damaging the plates 81 and 82.

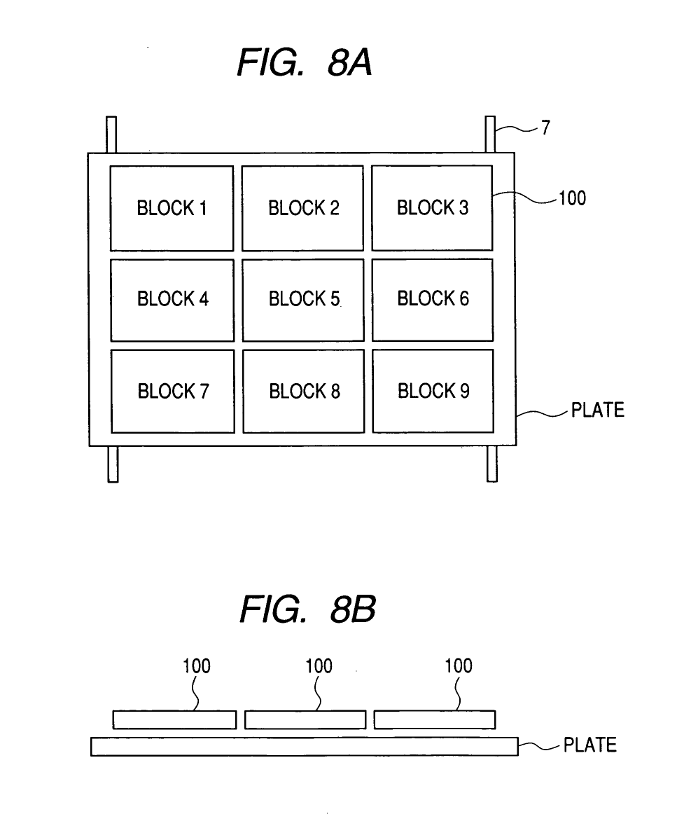

FIGS. 8A and 8B show heating mechanism for heating the plates and FIG. 8A is a plan diagram thereof and FIG. 8B is a front elevation thereof.

In the example shown in FIG. 5, for a purpose of vulcanizing the connecting member in the seal bonding process and the like, three units each above the face plate 82 along its vertical and horizontal directions respectively, that is, being divided into nine blocks in total of the heaters 100 of heating the plates 81 and 82 are arranged oppositely. In the present embodiment, a sheath heater is used as a heater 100, but in its place, a lump heater may be used. In addition, a configuration with the heater 100 heating the face plate 82 was described in the above, and otherwise a configuration with the heater heating the rear plate 81 or a configuration to heat the both plates 81 and 82 may be employed.

### EXAMPLES

Taking specific examples, a method of manufacturing an outer fence device of the present invention will be described in detail as follows.

### Example 1

An example hereof will be described with reference to FIGS. 1A, 1B and 1C etc. In the present example, using a rear plate 81 with an SiO₂ film being formed to derive 3000 Å (300 nm) thickness and moreover electron-emitting devices and wiring on a plate made of PD-200 (produced by ASAHI GLASS CO., LTD.) being electric glass in a 900 mm×580 mm rectangular and 2.8 mm thickness, a face plate 82 with a phosphor film 84 and a getter 9 being formed on a plate made of PD-200 (produced by ASAHI GLASS CO., LTD.) being electric glass in a 900 mm×580 mm rectangular and 2.8 mm thickness, a supporting frame 86 made of blue plate glass in a 830 mm×510 mm rectangular and with surrounding wall width being 4 mm and with 1.3 mm thickness and a spacer 205 with a (not shown) antistatic film being formed on a front surface of a plate made of PD-200 (produced by ASAHI GLASS CO., LTD.) being electric glass with 780 mm length, 200 mm width and 1.6 mm height, a hermetically sealed container of an image display apparatus was made. As a connecting member between the respective plates 81 and 82 and the supporting frame 86, In was used. Thickness of the connecting member was set to 300 μm prior to seal bonding and to 150 μm subject to seal bonding.

Prior to putting into the seal bonding chamber, one side of the two plates 81 and 82 underwent positioning each other and joining with the positioning device 200 (see FIG. 3) and the positioning spring 180 (see FIGS. 7A and 7B).

Temperature at the time of the vacuum baking process was set to 400° C. The other side of the face plate 82 which is opposite to one side which was positioned and held by the positioning spring 180 was supported and lifted in the position with 5 mm apart from the corner thereof with the arm 7 (see FIGS. 6A and 6B). At this time, the face plate 82 was lifted to reach the height of 3 mm from the upper surface of the spacer 205 disposed on the rear plate 81. In a state of being thus lifted, baking was implemented for an hour, and thereafter the rear plate 81 and the face plate 82 underwent seal bonding via the supporting frame 86 so that a hermetically sealed container of an image display apparatus was made.

### Example 2

In the present example, after retaining the face plate 82 in a state apart above the rear plate 81 to such an extent that the face plate 82 will not come into contact with the spacer 205 on the rear plate 81 at the time of the vacuum baking process, a hermetically sealed container of an image display apparatus was made as in Example 1.

### Example 3

In the present example, prior to putting into the seal bonding chamber, 7 sets of two plates 81 and 82 having undergone positioning each other to be held with the positioning spring 180 (see FIGS. 7A and 7B) were prepared, and the 7 sets were collectively brought into seal bonding processing with a batch processing type apparatus that could put them in simultaneously. Otherwise, a hermetically sealed container of an image display apparatus was made as in Example 1.

This application claims priority from Japanese Patent Application No. 2004-243621 filed Aug. 24, 2004, which is hereby incorporated by reference herein.

What is claimed is:

1. A method of manufacturing a hermetically sealed container comprising a process of disposing, in an atmosphere of reduced pressure, a pair of substrates in a state that respective substrate surfaces faces each other to form a gap therebetween, and a side of one of the substrates is joined with the other substrate; and a process of widening said gap between another side of said one of substrates and said other substrate in said atmosphere of reduced pressure.

2. The method of manufacturing a hermetically sealed container according to claim 1, wherein join of a side of one of substrates to the other substrate is join to hold relative position of said pair of substrates in the direction along a substrate surface of said pair of substrates.

3. The method of manufacturing a hermetically sealed container according to claim 2, wherein join of said side of one of substrates to the other substrate is implemented with a connecting member to intervene between said side of one of substrates and said other substrate.

4. The method of manufacturing a hermetically sealed container according to claim 2, wherein join of said side of one of substrates to the other substrate is implemented with a supporting frame to intervene between said side of one of substrates and said other substrate.

5. The method of manufacturing a hermetically sealed container according to claim 2, wherein join of said side of one of substrates to the other substrate is movable join in the direction other than the direction along a substrate surface of said pair of substrates.

6. The method of manufacturing a hermetically sealed container according to claim 1 further having a process of seal bonding said one of the substrates to said other substrate in spacing each other.

7. A method of manufacturing an image display apparatus comprising a hermetically sealed container involving electron-emitting devices and a phosphor film to which electrons emitted from said electron-emitting devices are radiated, wherein forming of said hermetically sealed container comprises a process of disposing, in an atmosphere of reduced pressure, a pair of substrates in a state that respective substrate surfaces faces each other to form a gap therebetween and a side of one of the substrates is joined with the other substrate; and a process of widening said gap between another side of said one of substrates and said other substrate in said atmosphere of reduced pressure.

8. The method of manufacturing an image display apparatus according to claim 7, wherein join of a side of one of substrates to the other substrate is join to hold relative position of said pair of substrates in the direction along a substrate surface of said pair of substrates.

9. The method of manufacturing an image display apparatus according to claim 8, wherein join of said side of one of substrates to the other substrate is implemented with a connecting member to intervene between said side of one of substrates and said other substrate.

10. The method of manufacturing an image display apparatus according to claim 8, wherein join of said side of one of substrates to the other substrate is implemented with a supporting frame to intervene between said side of one of substrates and said other substrate.

11. The method of manufacturing an image display apparatus according to claim 8, wherein join of said side of one of substrates to the other substrate is movable join in the direction other than the direction along a substrate surface of said pair of substrates.

12. The method of manufacturing an image display apparatus according to claim 7 further having a process of seal bonding said one of the substrates to said other substrate in spacing each other.
